(19) United States
(12) Patent Application Publication
(10) Pub. No.: US 2026/0361650 A1
(43) Pub. Date: Nov. 12, 2026

(54) CONFIGURATIONS FOR CONGESTION CONTROL

(71) Applicant: MELLANOX TECHNOLOGIES, LTD., Yokneam (IL)

(72) Inventors: Omer Ytzhaki, Haifa (IL); Shahaf Shuler, Lohamei Hagetaot (IL); Yuval Avnery, Hahotrim (IL); Yossi Kuperman, Haifa (IL); Noam Katz, Ness Ziona (IL); Yuval Shpigelman, Netanya (IL)

(21) Appl. No.: 19/205,469

(22) Filed: May 12, 2025

(51) Int. Cl. H04L 47/122

(52) U.S. Cl. CPC H04L 47/122

(57) ABSTRACT

Systems and methods are directed toward a hybrid routing solution that can be implemented using different network protocols and different network topologies. Probes may be transmitted from network devices along different paths to determine whether a given path is active. If a path is considered to be inactive, traffic along the inactive path may be redirected to one or more alternative paths. One or more probes may be used to continue to monitor the inactive path and, if the path is repaired or otherwise becomes active again, traffic may be redirected to use the path.

### TECHNICAL FIELD

At least one embodiment pertains to routing configurations for network traffic. At least one embodiment pertains to routing configurations for network traffic in either multiplane or multipath network topologies.

### BACKGROUND

Traffic in a network, or between networks, may be routed using one or more processes in order to efficiently transmit information. Various types of devices may be used to route traffic, such as routers, switches, load balancers, and the like. The selection of a route for network traffic may be related to performance, reliability, and security of the network, and as a result, it is desirable to efficiently plan traffic throughput. However, various challenges such as congestion, link failures, misconfigurations, and bad actors may cause delays, losses, errors, and network instability. The challenges only increase as networks grow in size and complexity, thereby causing an increased expenditure of resources to plan network routing, which may lead to latency and overall less effective network performance.

### BRIEF DESCRIPTION OF THE DRAWINGS

Various embodiments in accordance with the present disclosure will be described with reference to the drawings, in which:

FIG. 1A illustrates an example environment for a multiplane network topography, in accordance with at least one embodiment;

FIG. 1B illustrates an example environment for a multipath network topography, in accordance with at least one embodiment;

FIG. 2 illustrates an example environment for a network path routing configuration, in accordance with at least one embodiment;

FIG. 3A illustrates an example call diagram for detecting a failed network path and updating a routing table, in accordance with at least one embodiment;

FIG. 3B illustrates an example call diagram for detecting a recovered network path and updating a routing table, in accordance with at least one embodiment;

FIG. 4A illustrates an example call diagram for detecting a failed network path and updating a routing table, in accordance with at least one embodiment;

FIG. 4B illustrates an example call diagram for detecting a recovered network path and updating a routing table, in accordance with at least one embodiment;

FIG. 5A illustrates an example process for updating a routing table, in accordance with at least one embodiment;

FIG. 5B illustrates an example process for updating a routing table, in accordance with at least one embodiment;

FIG. 5C illustrates an example process for updating a routing table, in accordance with at least one embodiment;

FIG. 5D illustrates an example process for updating a routing table, in accordance with at least one embodiment;

FIG. 6 illustrates components of a distributed system that can be utilized to update or perform inferencing using a machine learning model, according to at least one embodiment;

FIG. 7 illustrates an example data center system, according to at least one embodiment;

FIG. 8 illustrates a computer system, according to at least one embodiment;

FIG. 9 illustrates a computer system, according to at least one embodiment;

FIG. 10 illustrates at least portions of a graphics processor, according to one or more embodiments; and

FIG. 11 illustrates at least portions of a graphics processor, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles or machines, semi-autonomous vehicles or machines (e.g., in an in-cabin infotainment or digital or driver virtual assistant application)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), generative AI with large language models (LLMs), light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations using LLMs, systems for performing light transport simulation, systems for performing collaborative content creation for 3D assets, systems implemented at least partially using cloud computing resources, and/or other types of systems.

Approaches in accordance with various embodiments are directed toward a hybrid routing solution that can be implemented using different network protocols (e.g., Ethernet or InfiniBand (IB)) and/or different network topologies (e.g., multiplane or multipath), thereby providing a topology and/or protocol agnostic routing solution. Embodiments include transmitting probes (e.g., congestion control probes (CCPs), congestion control packets, etc.) across different paths and waiting for a response from a receiver. If a threshold failure metric is detected (e.g., a total number of failed packets, a number of sequential errors, exceeding a timeout, etc.) is detected, then it may be determined with a high level of confidence that a path is not operational. For Ethernet configurations, traffic may be gradually reduced along the path until a routing stack identifies the error and updates routing configurations for the system. For IB configurations, a network interface controller (NIC) may detect the failure and then modify the routing accordingly. As discussed herein, both the Ethernet and IB configurations may use NICs, but for the Ethernet configurations, one or more software stacks may execute and/or be managed by a host associated with the NIC. Over time, embodiments may continue to probe failed paths for recovery by periodically sending additional probes over the path. If a sufficient number of probes are returned, then it may be determined that the path is repaired, and the reverse operation of slowly opening traffic may be executed (for Ethernet configurations) until the routing stack is updated. For IB configurations, determination of a repaired path may be used to update routing paths directly at/by the NIC. Accordingly, systems and methods may be used to detect both failure and recovery of network paths and may further be protocol and topology agnostic.

Systems and methods of the present disclosure may be used to implement a hybrid routing solution that may use one or more of a software network stack and/or device congestion control associated with one or more NICs, among other options. One or more embodiments may be used to monitor traffic along one or more network paths to determine a first threshold failure metric, such as a number of failed transmissions as one non-limiting example, is satisfied. As discussed herein, a threshold of failed transmissions may be associated with a total number of failures, a number of consecutive failures, a number of failures over a period of time, and/or the like. In at least one embodiment, the network traffic may include one or more messages or data communications transmitted over a network, which as discussed herein may include a number of different network topologies or transmission protocols. The network traffic may further, or alternatively, include at least a first control probe and a second control probe transmitted along a network path between a first host device and a second host device. Upon determining that the threshold is satisfied, it may be determined, with a threshold likelihood (e.g., a high likelihood, a high confidence, a threshold confidence, etc.), that the network path is unavailable, and as a result, systems and methods may cause traffic along the network path to be reduced over a first period of time. The reduction is traffic may be implemented in an Ethernet configuration, but embodiments are not limited to use with Ethernet configurations, as discussed herein. As traffic along the path is reduced, a routing table, for the traffic, may be updated or otherwise modified to direct the traffic away from the network path. For example, an executing software stack may receive telemetry information for the network path and then make a determination that the network path is damaged or otherwise unavailable, and therefore, will update the routing configuration to avoid or otherwise limit transmission along the network path. Upon determining a path has failed or is otherwise unavailable, systems and methods may continue, periodically and/or upon command, to transmit additional control probes along the network path, even after the routing stack (in the Ethernet configuration) has been updated to redirect the network traffic. If it is determined that a second threshold number of successful transmissions, associated with at least a third control probe transmitted along the network path, is satisfied, then the reverse process may commence and traffic along the network path may be increased over a second period of time. For Ethernet configurations, increasing the traffic may cause the routing table to be updated. For other configurations, such as IB, the determination may be used to cause hardware, such as the NIC, to begin routing traffic along the recovered network path. In this manner, failed paths may be identified and routing may be updated until the failed paths are repaired.

As discussed herein, at least one embodiment of the present disclosure may be associated with first and second host network devices that include one or more NICs. A routing table, which may be associated with a software stack, may be controlled or otherwise managed by and/or at the NIC. The routing table may be associated with legacy software stacks, for example those configured by one or more users, and may be implemented into embodiments of the present disclosure without modification and/or changes, thereby permitting users to adopt improved routing configurations without the overhead of reworking routing table configurations for a new service. In one or more embodiments, the control probes may be transmitted along with network traffic that satisfies one or more size thresholds. As a result, control probes may not be transmitted for small (e.g., less than the size threshold) packets, and may be reserved for larger data transmissions. However, embodiments may include the use of control probes with different sizes of data, or any data transmission, to increase reliability of the network.

One or more embodiments of the present disclosure may be used to determine a size of a data packet, associated with a first request to transmit the data packet to a second NIC along a first path, exceeds a first threshold and then, upon determining the size exceeds the first threshold, may transmit a probe along the first path. The first threshold may be based, at least in part, on a type of traffic associated with the network. For example, an average data packet size may be determined over a period of time and then the first threshold may be based, at least in part, on the average data packet size, such as a percentage of the average data packet sizes. One or more properties of the probe may be used to determine that the first path is unresponsible. For example, a time out period may be evaluated to determine whether the first path is responsive. As another example, other properties may include a number of unresponsive messages, a number of consecutive unresponsive messages, and/or the like. If the first path is determined to be unresponsive, embodiments may then set a rate for the first path to a reduced value. The reduced value may be used, for example, by software stacks, to redirect or otherwise change one or more routing tables. As a result, a second request to transmit the data packet may use a second path due to the determination that the first path is unresponsive. Over time, additional probes may be transmitted along the first path to try and detect recovery of the first path. As discussed herein, the probes may be small, for example approximately one percent of the initial data, and therefore continuing to monitor the first path for potential recovery may not significantly hinder performance of the network. If the path is determined to be responsive (e.g., responses are received within the timeout, consecutive responses are received, etc.), then the rate for the first path may be changed such that the software stack and/or the NIC may begin to direct traffic back to the first path. For example, the rate may be changed to be greater than zero, thereby causing the software stack to update (in Ethernet configurations) and/or a status may be updated directly by the NIC to redirect traffic. Accordingly, systems and methods of the present disclosure may be used to update routing configurations in a variety of different network topologies (e.g., multiplane or multipath) and/or with different network protocols (e.g., Ethernet or IB).

Embodiments of the present disclosure may be used to update routing configurations based, at least in part, on a determination that a network path is unhealthy and/or unresponsive. At least one embodiment may include transmitting one or more probes along a network path between a first host device and a second host device. The one or more probes may be transmitted responsive to a request to transmit a data packet. Individual statuses of the one or more probes may be used to determine a health of the network path. For example, the health may be a value that is compared to a threshold or may be a binary determination that the path is sufficiently healthy or not. If the health is deemed insufficient (e.g., below a threshold, equal to a status, etc.), then a rate for the network path may be reduced, for example to zero or another value, which may cause the routing table to direct traffic away from the network path and toward a different network path. Thereafter, embodiments may monitor the network path to determine whether the path has recovered, and if so, may then reverse the rate reduction to cause the routing table to direct traffic back along the network path.

Variations of this and other such functionality can be used as well within the scope of the various embodiments as would be apparent to one of ordinary skill in the art in light of the teachings and suggestions contained herein.

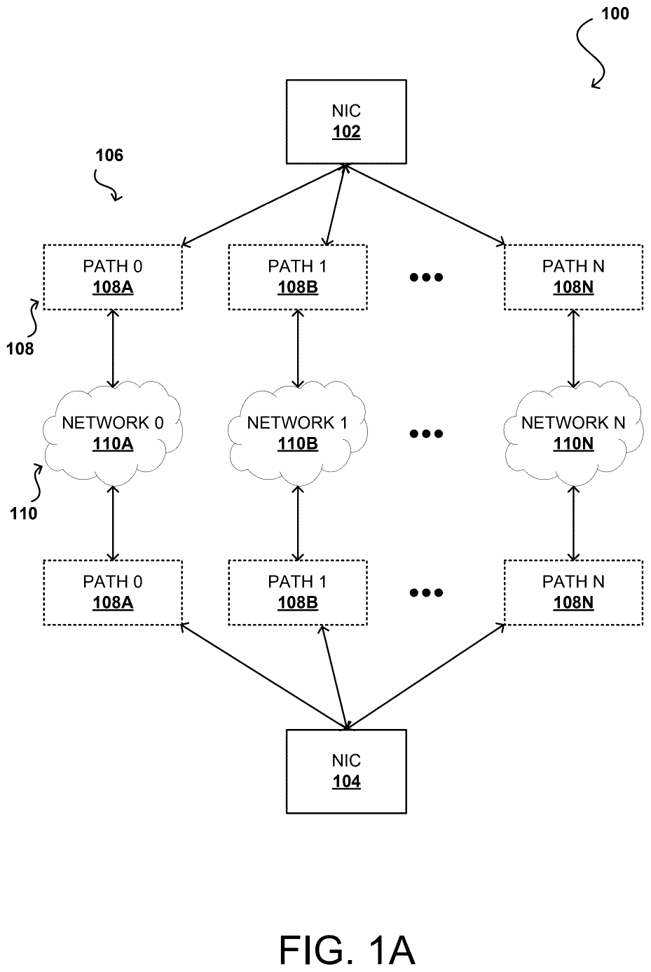

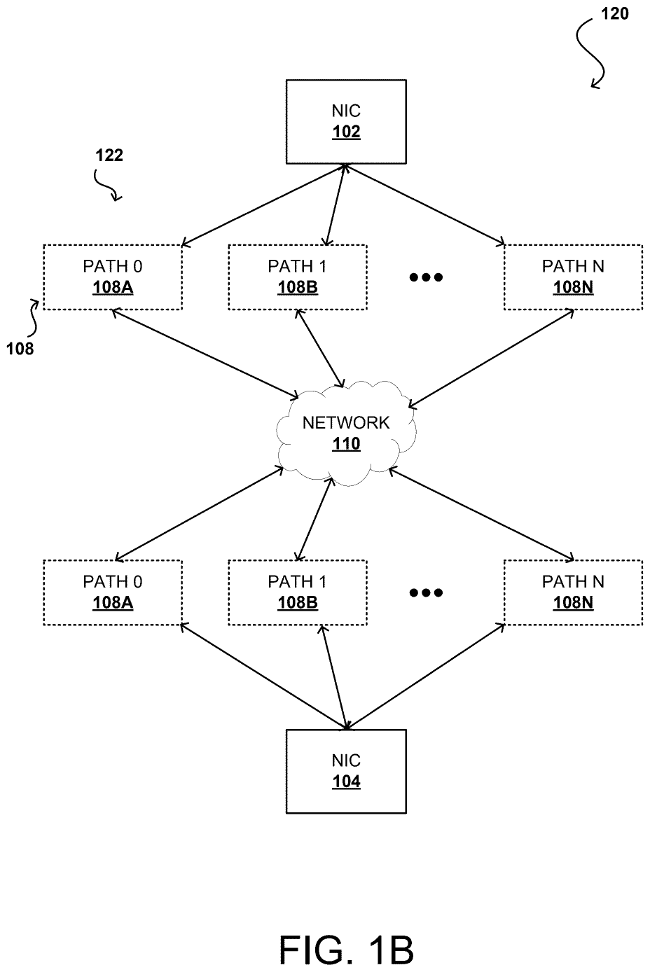

FIG. 1A illustrates an example environment 100 that may be used with embodiments of the present disclosure to transmit data between two or more devices. In this example, a multiplane network topology is illustrated in which a NIC 102 (e.g., a first NIC) is communicatively coupled to a NIC 104 (e.g., a second NIC) using multiplane topology 106, which in this example includes a set of paths 108 (e.g., network paths, planes, links, etc.) and networks 110. The multiplane topology includes multiple parallel networks that connect the end nodes (e.g., the NIC 102 and the NIC 104), each plane has its own set of links, switches, and routers, and each plane operates independently from the other planes. The illustrated NICs 102, 104, acting as the end nodes, have multiple ports, one for each plane, and can send and receive packets on any of the available planes. In at least one embodiment, a particular path may be selected, by the NIC 102, to transmit data to the NIC 104. For example, a first path (e.g., path 0 108A) may be selected and, as a result, data is transmitted along the first path via the network 0 110A.

FIG. 1B illustrates an example environment 120 that may be used with embodiments of the present disclosure to transmit data between two or more devices. In this example, a multipath network topology is illustrated in which the NIC 102 is communicatively coupled to the NIC 104 using multipath topology 122, which in this example includes the set of paths 108 (e.g., network paths, planes, links, etc.) and the network 110. The multiplane topology includes paths that may cross or overlap along the way in the network 110, creating more paths for traffic going from a source to a destination. For example, an initial transmission from the NIC 102 along the path 0 108A may cross at the network 110 and complete transmission along the path 1 108B to the NIC 104.

Embodiments of the present disclosure may be used with either the multiplane 106 or the multipath topologies 122 to route traffic based, at least in part, on a determination of path health using one or more probes. Systems and methods may include a routing solution for one or more network devices, such as a NIC, that combines at least a software (SW) routing stack and device probes, which may also be referred to as end-to-end congestion control probes. The SW routing stack may refer to a SW-based routing protocol that executes on a host or network device, which may include devices such as NICs, routers, switches, and/or gateways. The SW routing stack is responsible for maintaining one or more routing tables, exchanging routing information, and forwarding packets according to available routes, which may include available routes determined to be the “best” or otherwise have improved capacity over one or more other routes. The probes may refer to one or more data packets that are sent by the end devices (e.g., the NICs 102, 104) to measure the congestion level and the availability of the routes between them. The probes may be used to detect failed routes, with some degree of certainty (e.g., a threshold amount). Subsequently, one or more actions may be taken to avoid failed routes, such as adjusting the sending rate of the data packets according to the network conditions. In addition, the probes may be used to detect the recovery of previously failed routes. As discussed herein, one or more probes may be transmitted along with a data packet responsive to a request. Information associated with the probe, such as a time out value and/or a threshold number of sequentially failed probes, may be used to assess and determine a health of the network connection, which may cause one or more systems to adjust traffic routing.

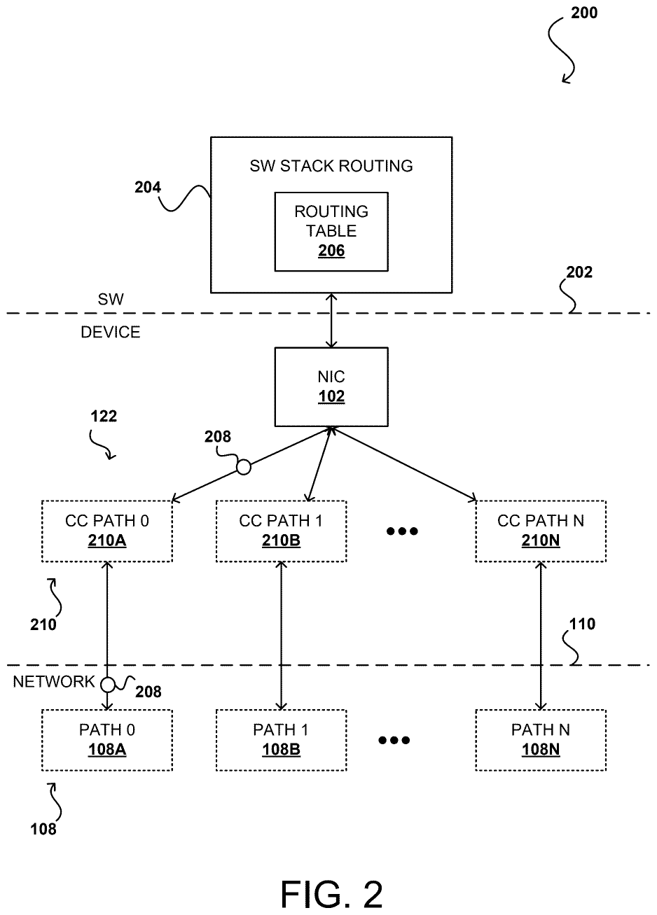

FIG. 2 illustrates an example of a routing configuration 200 that may be used with embodiments of the present disclosure. Systems and methods may be used to form a hybrid routing solution in which a SW routing stack periodically (e.g., at a set period of time, after a period of time between updates, upon receiving new information, etc.) updates one or more routing tables based, at least in part, on one or more of the network topology, the link state, and/or the routing metrics (e.g., hop count, bandwidth, delay, cost, etc.). The SW routing stack may also be used to monitor the network for any changes, such as link failures, node failures, or network partitioning, and propagate the updates to other network devices. In certain embodiments, the updates are propagated at a rate in the order of seconds. One or more embodiments may further use one or more network devices, such as end devices which may be NICs, as discussed herein, to send one or more probes (e.g., CCPs, end-to-end CCPs, etc.) to monitor or otherwise obtain information associated with one or more pathways associated with the network topology. Probes may be transmitted at regular intervals (e.g., hundreds of microseconds), in response to network events (e.g., timeouts), and/or combinations thereof. The probes may be data packets that carry information about the source, the destination, the sequence number, and/or the timestamp of the probe, such as when it was sent, received, and/or returned. Based on the response, even without considering the timestamp content, the sender can determine if a specific route to a node is available. Network topology may also be used to provide additional information, such as in the case of multipathing at the NIC, where the sender knows what path the probe was sent and received.

In at least one embodiment, a failure metric may be associated with consecutive failures or timeouts for a given probe. By counting consecutive probe timeouts, the sender can determine, with a high confidence (e.g., a confidence above a threshold), that a specific route is unavailable and as a result, reduce the data rate for traffic along the specific route. The reduction may include throttling the data rate or reducing the data rate down to zero, thus preventing introducing additional packets that will be lost and/or re-transmitted, which may introduce additional overhead to the network. In one or more embodiments, a period of time with the reduced data rate may trigger the SW networking stack routing to detect that either the rate to the given route has reduced dramatically or simply becomes unreachable and will update routing configurations to use one of the other available paths at the NIC. As discussed herein, embodiments may be topology and protocol agnostic. For example, systems and methods may be used with ethernet networks with a SW routing stack (e.g., Border Gateway Protocol (BGP)) running on the host device, such as a NIC host. Furthermore, systems and methods may also be used with a complete routing stack scheme where the device (e.g., the NIC) can detect failed routes as well as fix the routing tables independently, without the need for an external SW routing stack. Additionally, one or more embodiments may also be used with IB networks with a SW routing stack that runs on the NIC itself.

As shown in FIG. 2, the routing configuration 200 includes a SW stack 202 which executes a SW stack routing 204 including one or more routing tables 206. The routing table 206 may include rules or other parameters for routing network traffic that is provided to the NIC 102, such as data for transmission along the one or more paths 108. In operation, the NIC 102 may transmit one or more probes 208 along congestion control (CC) paths 210, which may be part of or also use the paths 108. As discussed herein, the one or more probes 208 may be used to gather information about the paths 108, such as a whether or not the path 108 is capable of receiving transmissions, among other information. In this example, different functions are shown split between components, such as the SW stack 202, the NIC 102, and the network 110. In one or more embodiments, the SW stack 202 may be executing on hardware associated with the NIC 102 and/or may be an integrated portion of the NIC 102.

The probes 208 may be transmitted responsive to a request to transmit data along the one or more paths 108. For example, the probes 208 may be generated and transmitted along with the data, but the probes 208 may be smaller than the size of the data. Size may refer to a disk size. For example, the data may be 100 kb and the probe may be 1 kb, and therefore, the probe is smaller than the data because the probe would occupy less disk space than the data. Similarly, the probe would use less bandwidth on the network than the data. In at least one embodiment, the probes 208 may only be transmitted if the data exceeds a threshold size. Additionally, or alternatively, the probes 208, due to their small size, may be periodically transmitted across some or all of the available paths 108 and/or congestion control paths 210. Information from the probes 208 may then be used by the SW routing stack 204 to adjust or update the routing table 206. For example, information indicative of a failed path or link may then be used to change routing procedures to avoid the failed path. It should be appreciated that the information from the probes may not be provided directly to the SW stack 202 and/or the SW stack routing 204, and instead, the NIC associated with the host may use information from the probes 208 to modify one or more properties that will be used by the SW routing stack 204 to adjust the routing tables 206. For example, the NIC may throttle traffic along a given path based on information from the probes 208. Upon receiving information that the path is throttled, the SW stacking routing 204 may then update the routing table 206. However, as discussed herein, for embodiments that include direct control of the routing table 206 by the NIC, information from the probes 208 may be used by the NIC to update the routing table 206. Embodiments, as discussed herein, may also monitor failed links or paths with additional probes 208 to determine whether a path or link has been repaired. In this manner, existing routing stacks may be used with updated hardware, such as NIC hardware, without overhead for users while providing the improved functionality associated with the probes 208.

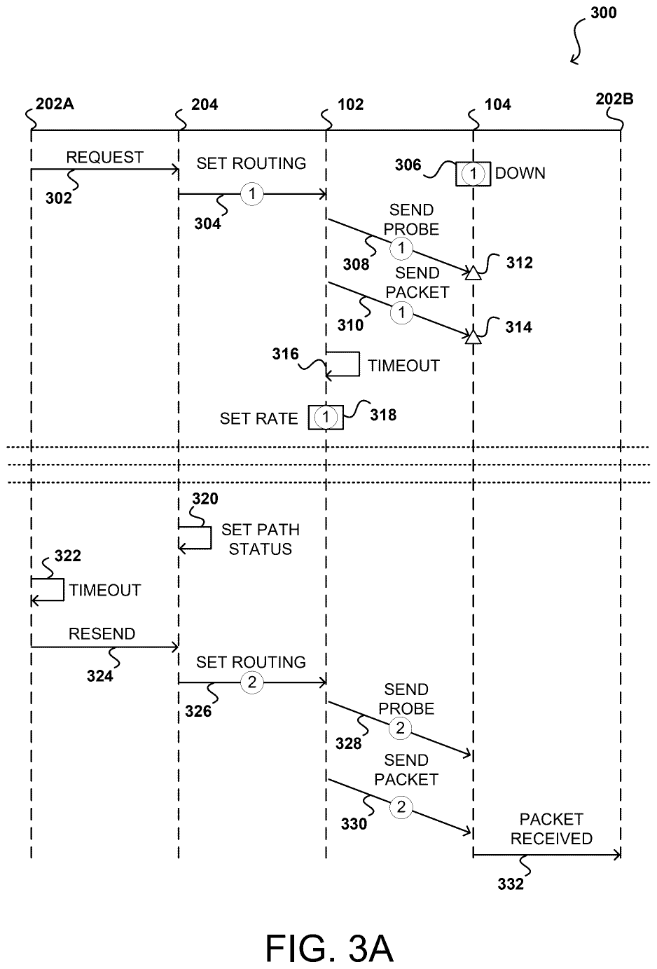

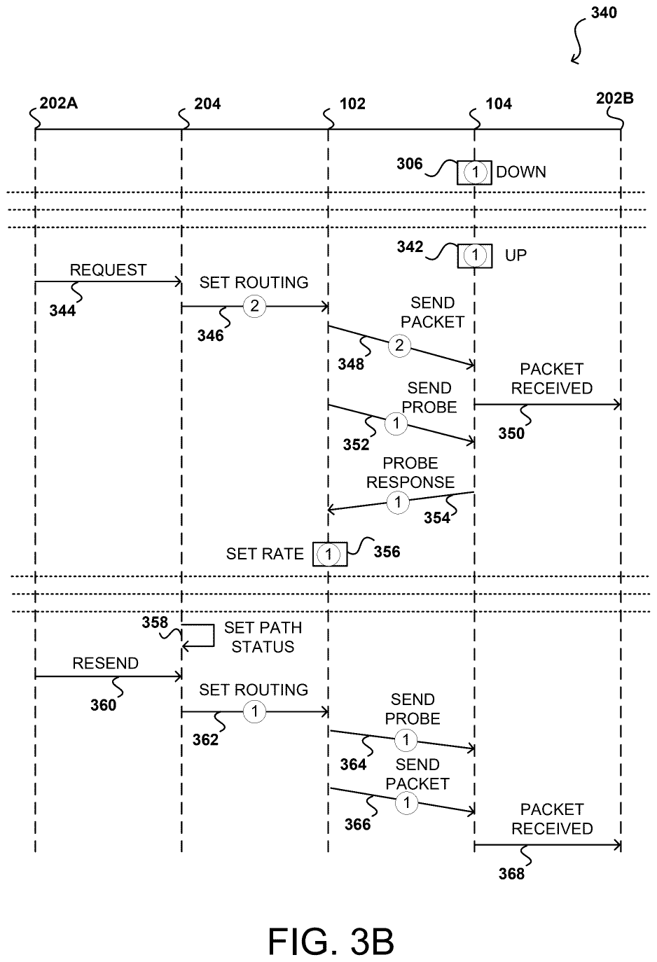

FIG. 3A illustrates an example call diagram 300 that may be used with embodiments of the present disclosure. The embodiment of FIG. 3A illustrates detection of a path failure in a configuration in which the SW stack is associated with the NIC. The illustrated call diagram 300 may be associated with a hybrid routing solution for detecting failure of one or more paths. This example includes two end devices, which are shown as the NICs 102, 104. Each NIC has an associated SW stack 202, in which the SW stack 202A is for the NIC 102 and the SW stack 202B is for the NIC 104. In at least one embodiment, the SW routing stack 204 runs on the host of the network devices, which in this example is the NIC 102.

To transmit a data packet, the SW 202A may send a request 302 to the SW routing stack 204 to determine a routing path to transmit one or more data packets to the NIC 104. The SW routing stack 204 may include one or more rules or guidelines and may select a particular path and set the routing 304 for the one or more data packets. In this example, the selected path (e.g., a first path, path one, etc.) is labeled by the numeral 1 and is shown as being down 306, which may refer to a link that is unable to send/receive information at a threshold rate. The status of the path may be based, at least in part, on one or more rules for the network. For example, a path may be considered “down” if bandwidth falls below a target threshold or if latency exceeds a target threshold, even if the path may technically be connected and/or capable of transmitting some quantity of data. In operation, the SW routing stack 204 may not be aware of the status of the path, and as a result, may continue to send traffic along the path, as shown by the numeral 1 marking the various transmissions. Embodiments of the present disclosure may be used to actively identify failure and/or recovery to enable appropriate updates to the SW routing stack 204. In this example, the NIC 102 may send 308 the probe (e.g., the probe 208) along the designated first path (e.g., the path marked by the numeral 1) and may also send 310 the data packet along the designated first path, also marked by the numeral 1. While the probe is shown as being sent first, it should be appreciated that the data packet may be sent first. Additionally, a single message may include both the probe and data packet.

Because the designated first path is down, there is an error 312 for the probe and an error 314 for the packet. For example, the probe and/or data packet may not reach the NIC 104 along the path, which may cause a timeout 316. As discussed herein, a single failure may not be sufficient to update or determine the path is down, and instead, one or more rules may be used to establish a status of a given path, which may include a consecutive number of failed probe transmissions, a number of probe transmissions within a period of time, and/or combinations thereof. Upon satisfying one or more failure criteria associated with the timeout 316, the NIC 102 may be able to determine, that the path has failed or otherwise is insufficient for continued traffic, and therefore, may change a path status as being unavailable and/or may set a rate 318 for the first path, such as a rate of 0 to prevent further traffic along the first path.

Over time, due to the rate being reset, such as to zero, the SW routing stack 204 may update the path status 320 to be unavailable, which may lead to a timeout 322 at the SW 202A. The timeout may cause the SW 202A to transmit a request to re-send the packet 324, where the SW routing stack 204 may subsequently set the routing 326 for the transmission along a second path, designated by the numeral 2. The NIC 102 may then transmit information according to the routing from the SW routing stack 204, which may include sending another probe 328 and sending the data packet 330. Because the second path is live, the packet may be received at the NIC 104 and then received 332 at the SW 202B. In this manner, the probes may be used to identify errors along routing paths and then to actively update routing tables.

FIG. 3B illustrates an example call diagram 340 that may be used with embodiments of the present disclosure. The embodiment of FIG. 3B illustrates detection of path recovery in a configuration in which the SW stack is associated with the NIC. The illustrated call diagram 340 may be associated with a hybrid routing solution for detecting recovery after failure of one or more paths. This example also includes two end devices, which are shown as the NICs 102, 104. Each NIC in the illustrated embodiment includes the associated SW 202A, 202B, as discussed with reference to FIG. 3A, along with the, the SW routing stack 204 run on the host of the network devices, which in this example is also the NIC 102.

The illustrated embodiment may be considered a continuation of the example of FIG. 3B in which a path, such as a first path, is down 306, as shown by the numeral 1. Based on the first path being down, the SW routing stack 204 may be updated to transmit traffic along the second path, as shown by the numeral 2. Over time, the first path may recover and be considered to be up 342. As discussed herein, the path being up may refer to the path being capable of transmitting a threshold quantity of information and/or having below a threshold latency, among other options. In operation, the SW routing stack 204 may still be using the second path and may not be aware that the first path is now recovered and operational. As a result, a request 344 to send a packet from the NIC 102 to the NIC 104 may be received at the SW routing stack 204, which may set the routing configuration 346 to continue to use the second path. Accordingly, the NIC 102 receiving the instructions may send the packet 348 using the second path, which may be received 350 at the SW 202B via the NIC 104. Embodiments of the present disclosure may be used to monitor and/or track recovery for different paths. As a result, a probe may be sent 352 along the first path, as shown by the numeral 1. Because the first path is now up, a response 354 from the probe may be received at the NIC 102. In this example, the NIC 102 determines the path is now recovered, for example by receiving a threshold number of responses from the first path, or some other criteria, and may then set the rate 356 for the first path to be greater than zero, thereby specifying that the first path is now available.

Over time, the SW routing stack 204, due to the rate being reset to a value greater than zero, may update the path status 358 to be available, which may be associated with an update to one or more routing tables. Accordingly, a subsequent request 360 to send a packet to the NIC 104 may set a routing path 362 along the active first path, as shown by the numeral 1. Accordingly, the NIC 102 may follow the routing path to send 364, 366 a probe and a packet to the NIC 104 using the first path. The packet may then be received 368 at the SW 202B. In this manner, the SW routing stack 204 eventually detects the recovery of the previously failed route and updates the routing tables accordingly. The SW routing stack 204 may then resume forwarding packets through the recovered route. The data packets sent by the NICs 102, 104 are then delivered to the destination through the first path, in addition to other available paths, providing higher bandwidth and reduced latency of data transmission.

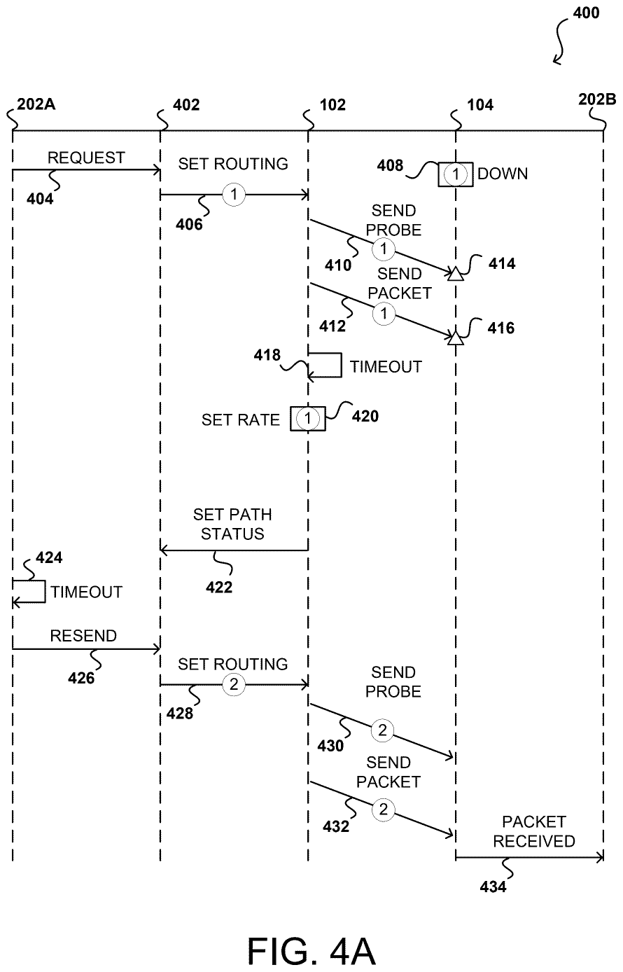

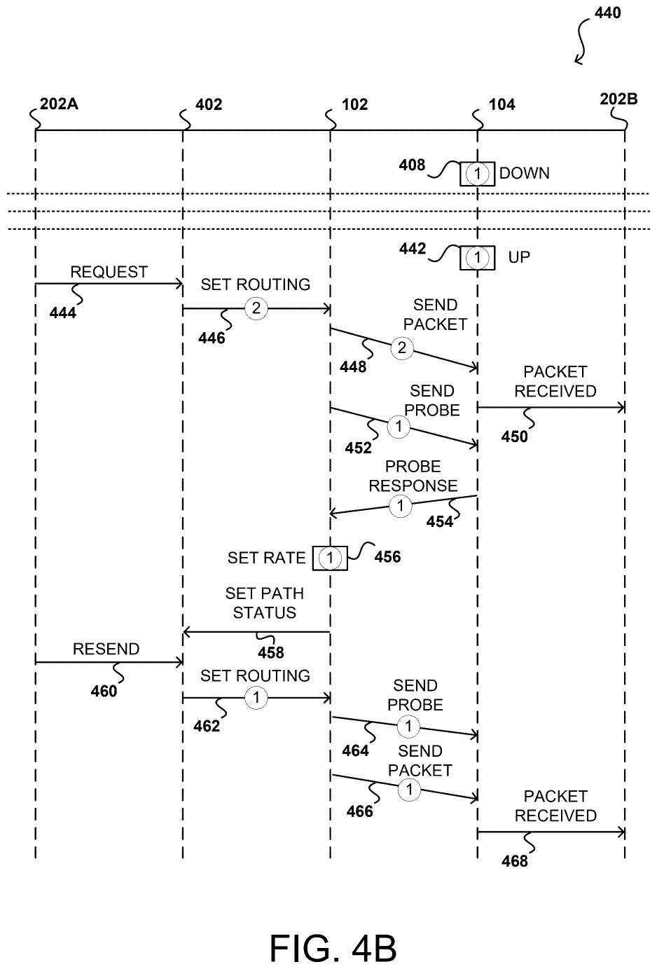

FIG. 4A illustrates an example call diagram 400 that may be used with embodiments of the present disclosure. The embodiment of FIG. 4A illustrates detection of a path failure in a configuration in which the SW stack is executing on the NIC. The illustrated call diagram 400 may be associated with a hybrid routing solution for detecting failure of one or more paths. This example includes two end devices, which are shown as the NICs 102, 104. Each NIC is associated with its own SW 202A, SW 202B. In at least one embodiment, the SW routing stack 204 runs on the NIC itself, as opposed to the configuration of FIGS. 3A and 3B in which the SW stack may operate using an additional layer of software or host.

To transmit a data packet, the SW 202A may send a request 404 to the SW routing stack 402 to determine a routing path to transmit one or more data packets to the NIC 104 via the NIC 102. As discussed herein, the SW routing stack 402 may include one or more rules or guidelines and may select a particular path and set the routing 406 for the one or more data packets. In this example, the selected path (e.g., a first path, path one, etc.) is down 408, which is noted by the numeral 1 representing the first path. However, the SW routing stack 204 may not be aware of the status of the path at the time of the request, and as a result, may continue to send traffic along the path, as shown by the numeral 1 along the various pathways. Embodiments of the present disclosure may leverage the use of the on-board SW routing stack 402 to rapidly provide notice of the path failure and update associated routing tables. The SW routing stack 402 may then stop forwarding packets through the failed route, and direct the packets to an alternative route. Accordingly, data packets may be delivered via the alternative route, with minimal delay and loss.

In this example, the NIC 102 may send 410 the probe (e.g., the probe 208) along the designated first path (e.g., the path marked by the numeral 1) and may also send 412 the data packet along the designated first path. While the probe is shown as being sent first, it should be appreciated that the data packet may be sent first. Additionally, a single message may include both the probe and data packet.

Because the designated first path is down, there is an error 414 for the probe and an error 416 for the packet. The errors may be a non-acknowledgement of the packet or probe, a dropped packet or probe, and/or combinations thereof. For example, the probe and/or data packet may not reach the NIC 104 along the path, which may cause a timeout 418. Upon determining the timeout 418 at the NIC 102, the NIC 102 may be able to determine, for example based on some threshold criteria associated with one or more probes, that the path has a failure or other error, and therefore, may change a path status as being unavailable and/or may set a rate 420 for the first path, such as a rate of 0 to prevent further traffic along the first path.

In this example, the SW routing stack 402 is managed at the NIC 102, and as a result, the NIC 102 may transmit 422 a command to set the path status for the first path to unavailable, which may lead to a timeout 424 at the SW 202A. The timeout may cause the SW 202A to transmit a request to re-send the packet 426, where the SW routing stack 204 may subsequently set the routing 428 for the transmission along a second path, designated by the numeral 2. The NIC 102 may then transmit information according to the routing from the SW routing stack 402, which may include sending another probe 430 and sending the data packet 432. Because the second path is live, the packet may be received at the NIC 104 and then received 434 at the SW 202B. In this manner, the probes may be used to identify errors along routing paths and then to actively update routing tables.

FIG. 4B illustrates an example call diagram 440 that may be used with embodiments of the present disclosure. The embodiment of FIG. 4B illustrates detection of path recovery in a configuration in which the SW stack executes at the NIC. The illustrated call diagram 440 may be associated with a hybrid routing solution for detecting recovery after failure of one or more paths. This example also includes two end devices, which are shown as the NICs 102, 104. Each NIC in the illustrated embodiment includes associated SW 202A, 202B, as discussed with reference to FIG. 4A, along with the SW routing stack 402, executing on the NIC 102.

The illustrated embodiment may be considered a continuation of the example of FIG. 4A in which a path, such as a first path, is down 408, as shown by the numeral 1. Based on the first path being down, the SW routing stack 402 may be updated to transmit traffic along the second path, as shown by the numeral 2. Over time, the first path may recover and be considered to be up 442, as discussed herein. However, the SW routing stack 402 may still be using the second path. As a result, a request 444 to send a packet from the NIC 102 to the NIC 104 may be received at the SW routing stack 402, which may set the routing configuration 446 to continue to use the second path. Accordingly, the NIC 102 receiving the instructions may send the packet 448 using the second path, which may be received 450 at the SW 202B via the NIC 104. Embodiments of the present disclosure may be used to monitor and/or track recovery for different paths. As a result, a probe may be sent 452 along the first path, as shown by the numeral 1. Because the first path is now up, a response 454 from the probe may be received at the NIC 102. In this example, the NIC 102 determines the path is now recovered, for example by receiving a threshold number of responses from the first path, or some other criteria, and may then set the rate 456 for the first path to be greater than zero, thereby specifying that the first path is now available.

In this example, the SW routing stack 402 is managed at the NIC 102, and as a result, the NIC 102 may transmit 458 a command to set the path status for the first path to be available. Accordingly, a subsequent request 460 to send a packet to the NIC 104 may set a routing path 462 along the active first path, as shown by the numeral 1. Accordingly, the NIC 102 may follow the routing path to send the probe 464 and the packet 466 to the NIC 104 using the first path. The packet may then be received 468 at the SW 202B. In this manner, the SW routing stack 402 is directly updated upon determination of recovery of a failure path. The SW routing stack 402 may then resume forwarding packets through the recovered route. The data packets sent by the NICs 102, 104 are then delivered to the destination through the first path, in addition to other available paths, providing higher bandwidth and reduced latency of data transmission.

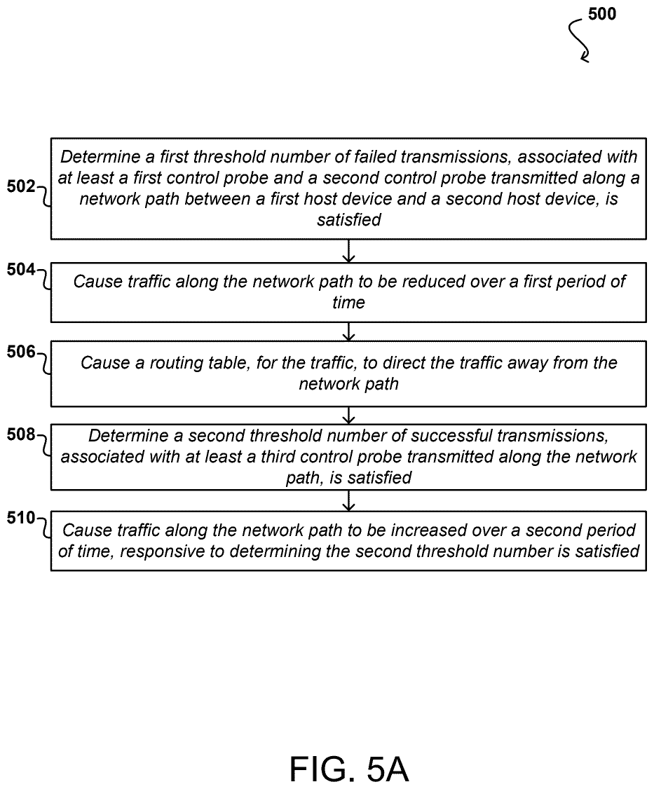

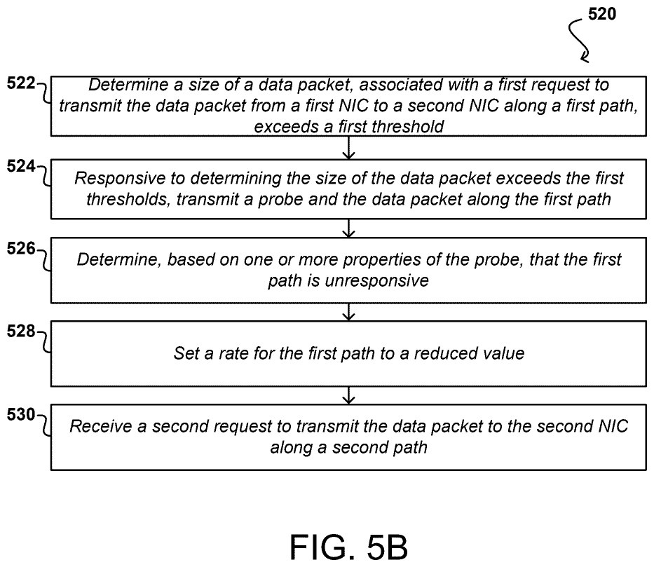

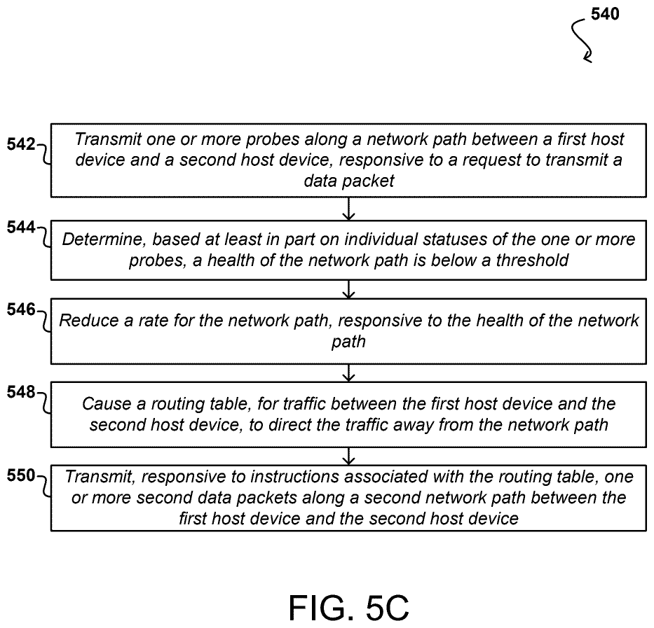

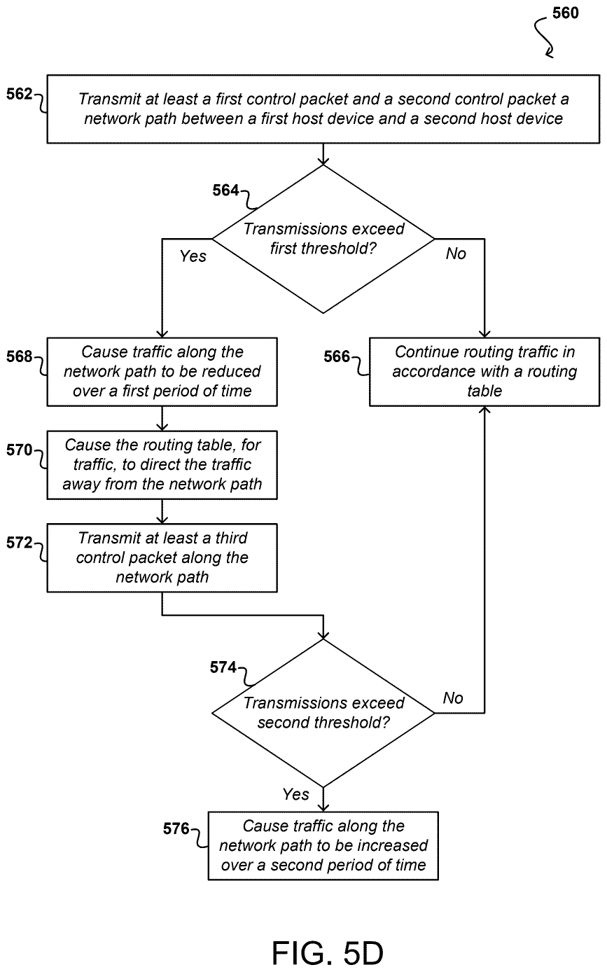

FIG. 5A illustrates an example process 500 that can be used to update one or more routing tables, in accordance with various embodiments. It should be understood that for this and other processes presented herein that there may be additional, fewer, or alternative operations performed in similar or alternative orders, or at least partially in parallel, within the scope of the various embodiments unless otherwise specifically stated. Further, while this example refers to ports, it should be understood that various other components may also use such a process within the scope of various embodiments. In this example, it is determined that a first threshold number of failed transmissions, associated with at least a first control probe and a second control probe transmitted along a network path between a first host device and a second host device, is satisfied 502. The first threshold number may be associated with one or more failure criteria. As discussed herein, a number of failed transmissions is one non-limiting example of failure criteria, which may also include examples such as consecutive failures, a number of failures over a period of time, timeouts, and/or combinations thereof. One or more embodiments may cause traffic along the network path to be reduced over a first period of time 504. For example, systems and methods may reset a rate or throttle a rate, which may include setting a rate to zero along a given path to prevent further traffic along the path.

Systems and methods may further cause a routing table, for the traffic, to direct the traffic away from the network path 506. In one or more embodiments, the routing table may be directed to be updated by a network device, such as a NIC. In other embodiments, the routing table may be updated after receiving information associated with the path, such as at a software stack executed at a host. As a result, future traffic associated with the network path may be routed to a different path. In one or more embodiments, a failed path may recover. For example, systems and methods may determine a second threshold number of successful transmissions, associated with at least a third control probe transmitted along the network path, is satisfied 508. Satisfying the second threshold number may be indicative of a recovered path. If it is determined that the path is recovered, for example within some confidence thresholds, then systems and methods may be used to cause traffic along the network path to be increased over a second period of time 510. Thereafter, a status for the path may be updated and routing configurations may then proceed to direct traffic along the recovered path.

FIG. 5B illustrates an example process 520 that can be used to update one or more routing tables, in accordance with various embodiments. In this example, a size of a data packet associated with a first request to transmit the data packet from a first NIC to a second NIC along a first path may be determined to exceed a first threshold 522. For example, one or more embodiments may be associated with using probes to evaluate network paths, but may not transmit probes if the associated message is below a threshold size. In at least one embodiment, responsive to determining the size of the data packet exceeds the first threshold, a probe may be transmitted with the data packet along the first path 524. The probe may be a separate transmission or may be transmitted along with the data packet. One or more properties of the probe may be used to determine that the first path is unresponsive 526. For example, the properties may include timestamps to indicate that a timeout has been satisfied for probe transmissions. As another example, one or more properties may be associated with whether or not the probe was received or an acknowledgment message for the probe was received. Systems and methods may set a rate for the first path to a reduced value for the unresponsive path 528. The reduced value may cause a routing table to be updated, either by the NIC itself or by an executing SW routing stack. Because the routing table is updated, a second request to transmit the data packet may include a request to transmit the data packet to the second NIC along a second path 530. As a result, failed or unresponsive paths may be quickly identified and removed from routing tables.

FIG. 5C illustrates an example process 540 that can be used to update one or more routing tables, in accordance with various embodiments. In this example, systems and methods may transmit one or more probes along a network path between a first host device and a second host device 542. Transmission of the probes may be responsive to a request to transmit a data packet. For example, software executing on the first host device may submit a request to transmit data to the second host device. A health a network path may be determined based, at least in part, on individual statuses of the one or more probes 544. For example, properties associated with the one or more probes may be used to determine network path health, such as determining whether a number of probes have failed, among other options. The health of the network path may be used as at least one factor in reducing a rate for the network path 546. By way of example, if the health is below a threshold or associated with a set status or attribute, then the rate may be reduced. Reducing the rate for the path may cause a routing table to direct traffic away from the network path 548. The routing table may be updated to use one or more alternative paths 548, and therefore, one or more data packets may be transmitted along a second network path between the first host device and the second host device 550, for example based on instructions from the routing table. In this manner, failed or weak paths may be avoided to improve data transmission.

FIG. 5D illustrates an example process 560 that can be used to update one or more routing tables, in accordance with various embodiments. In this example, a first control packet and a second control packet are transmitted along a network path between a first host device and a second host device 562. The transmission may be responsive to a request to transmit a data packet or other traffic along the network path. It may then be determined whether a first number of transmissions exceeds a first threshold 564, such as a first threshold associated with a number of failed transmissions. If not, then it may be determined with a level of confidence that the network path is up and operational, and therefore, traffic may continue to be routed in accordance with one or more routing tables 566. However, if it is determined that the first number of transmission exceeds the first threshold, then one or more embodiments may cause traffic along the network path to be reduced over a first period of time 568. For example, systems and methods may reset a rate or throttle a rate, which may include setting a rate to zero along a given path to prevent further traffic along the path.

Systems and methods may further cause a routing table, for the traffic, to direct the traffic away from the network path 570. In one or more embodiments, the routing table may be directed to be updated by a network device, such as a NIC. In other embodiments, the routing table may be updated after receiving information associated with the path, such as at a software stack executed at a host. As a result, future traffic associated with the network path may be routed to a different path. In one or more embodiments, a failed path may recover. In order to identify recovered paths, one or more embodiments may transmit at least a third control packet along the network path 572. It may then be determined whether a second number of transmissions exceeds a second threshold 574, such as a second threshold associated with a number of successful transmissions. If not, then it may be determined with a level of confidence that the network path is still down and/or non-operational, and therefore, traffic may continue to be routed in accordance with one or more routing tables 566. However, if it is determined that the second number of transmissions exceeds the second threshold, then one or more embodiments may cause traffic along the network path to be increased over a second period of time 576. Resetting the rate, for example, by permitting traffic along the network path, may later cause additional updates to the routing table, as discussed herein. Accordingly, routing tables may be adjusted based on information associated with the control packets.

As discussed, aspects of various approaches presented herein can be lightweight enough to execute on a device such as a client device, such as a personal computer or gaming console, in real time. Such processing can be performed on, or for, content that is generated on, or received by, that client device or received from an external source, such as streaming data or other content received over at least one network. In some instances, the processing and/or determination of this content may be performed by one of these other devices, systems, or entities, then provided to the client device (or another such recipient) for presentation or another such use.

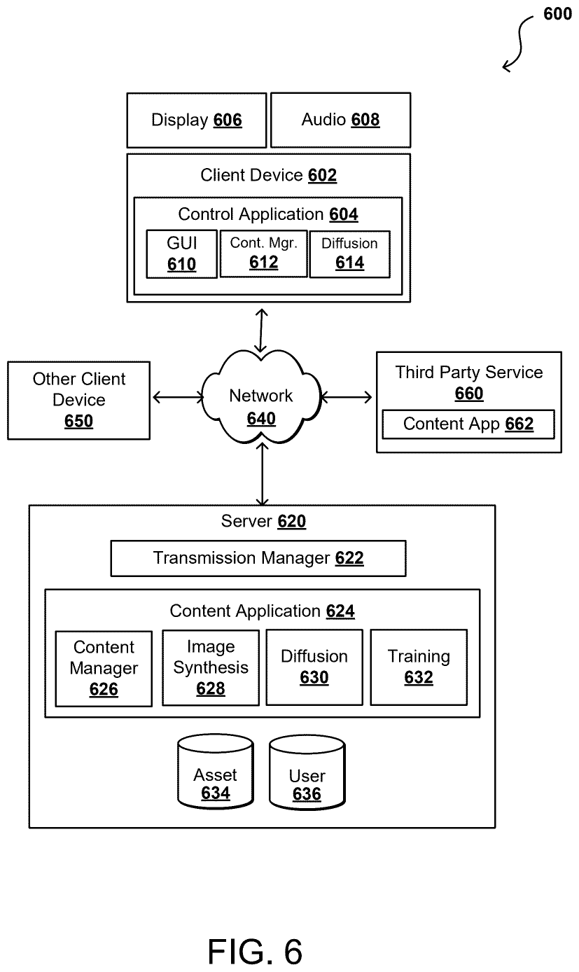

As an example, FIG. 6 illustrates an example network configuration 600 that can be used to provide, generate, modify, encode, process, and/or transmit image data or other such content. In at least one embodiment, a client device 602 can generate or receive data for a session using components of a control application 604 on client device 602 and data stored locally on that client device. In at least one embodiment, a content application 624 executing on a server 620 (e.g., a cloud server or edge server) may initiate a session associated with at least one client device 602, as may utilize a session manager and user data stored in a user database 636, and can cause content such as one or more digital assets (e.g., object representations) from an asset repository 634 to be determined by a content manager 626. A content manager 626 may work with an image synthesis module 628 to generate or synthesize new objects, digital assets, or other such content to be provided for presentation via the client device 602. In at least one embodiment, this image synthesis module 628 can use one or more neural networks, or machine learning models, which can be trained or updated using a training module 632 or system that is on, or in communication with, the server 620. This can include training and/or using a diffusion model 630 to generate content tiles that can be used by an image synthesis module 628, for example, to apply a non-repeating texture to a region of an environment for which image or video data is to be presented via a client device 602. At least a portion of the generated content may be transmitted to the client device 602 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding control application 604, which may also or alternatively include a graphical user interface 610, content manager 612, and image synthesis or diffusion module 614 for use in providing, synthesizing, modifying, or using content for presentation (or other purposes) on or by the client device 602. A decoder may also be used to decode data received over the network 640 for presentation via client device 602, such as image or video content through a display 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from server 620, or user database 636, to client device 602. In at least one embodiment, at least a portion of this content can be obtained, enhanced, and/or streamed from another source, such as a third party service 660 or other client device 650, that may also include a content application 662 for generating, enhancing, or providing content. In at least one embodiment, portions of this functionality can be performed using multiple computing devices, or multiple processors within one or more computing devices, such as may include a combination of CPUs and GPUs.

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

### Data Center

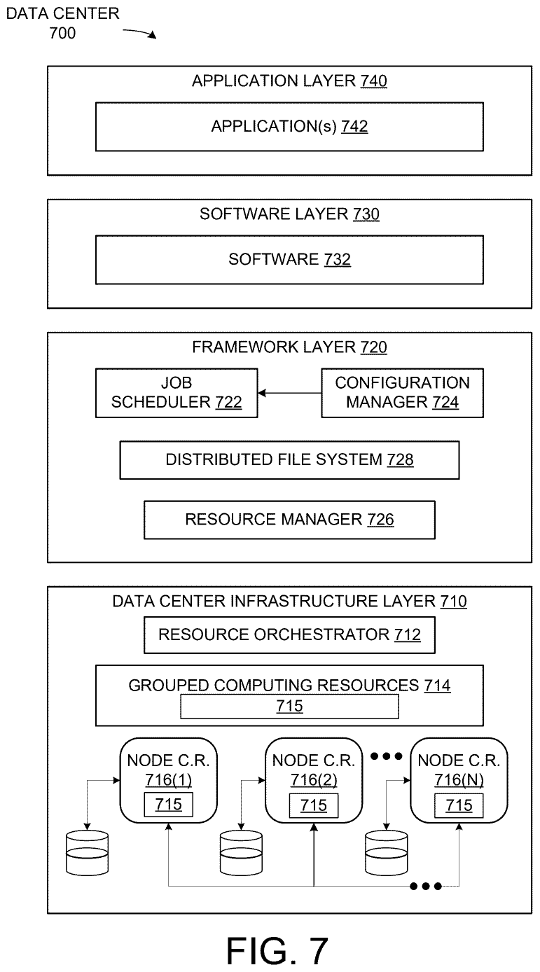

FIG. 7 illustrates an example data center 700, in which at least one embodiment may be used. In at least one embodiment, data center 700 includes a data center infrastructure layer 710, a framework layer 720, a software layer 730, and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 716(1)-716(N) and/or grouped computing resources 714. In at least one embodiment, resource orchestrator 712 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may use distributed file system 728 for large-scale data processing (e.g., “big data”). In at least one embodiment, job scheduler 722 may include a Spark driver to facilitate scheduling of workloads supported by various layers of data center 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resource 814 at data center infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. The one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 728 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underused and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 7 for inferencing or predicting operations based, at least in part, on weight parameters calculated using neural network training operations, neural network functions and/or architectures, or neural network use cases described herein.

Such components can be used for path routing.

### Computer Systems

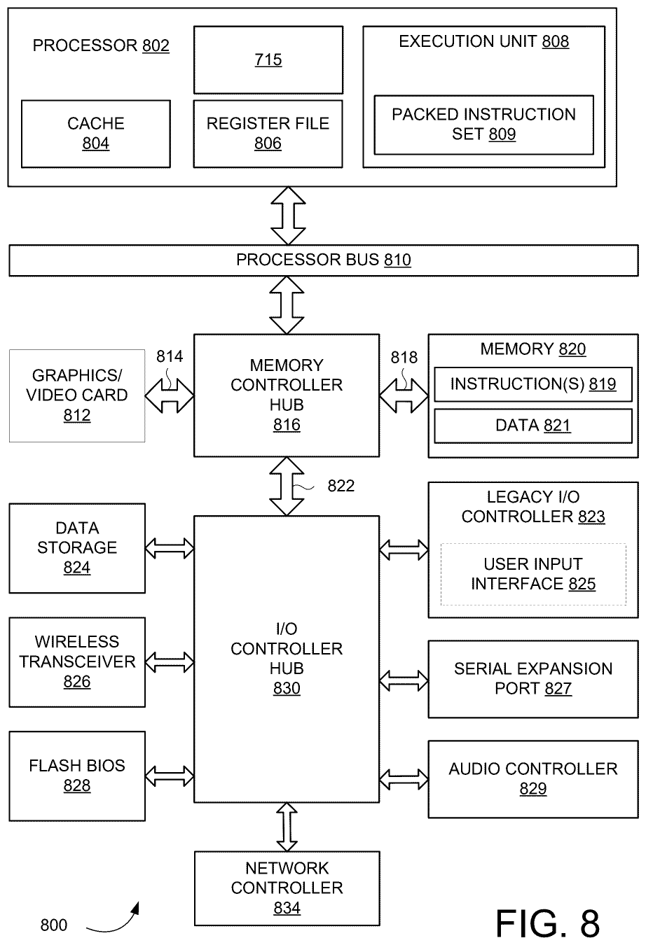

FIG. 8 is a block diagram illustrating an exemplary computer system, which may be a system with interconnected devices and components, a system-on-a-chip (SOC) or some combination thereof 800 formed with a processor that may include execution units to execute an instruction, according to at least one embodiment. In at least one embodiment, computer system 800 may include, without limitation, a component, such as a processor 802 to employ execution units including logic to perform algorithms for process data, in accordance with present disclosure, such as in embodiment described herein. In at least one embodiment, computer system 800 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 800 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 800 may include, without limitation, processor 802 that may include, without limitation, one or more execution units 808 to perform machine learning model training and/or inferencing according to techniques described herein. In at least one embodiment, computer system 800 is a single processor desktop or server system, but in another embodiment computer system 800 may be a multiprocessor system. In at least one embodiment, processor 802 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 802 may be coupled to a processor bus 810 that may transmit data signals between processor 802 and other components in computer system 800.

In at least one embodiment, processor 802 may include, without limitation, a Level 1 (“L1”) internal cache memory (“cache”) 804. In at least one embodiment, processor 802 may have a single internal cache or multiple levels of internal cache. In at least one embodiment, cache memory may reside external to processor 802. Other embodiments may also include a combination of both internal and external caches depending on particular implementation and needs. In at least one embodiment, register file 806 may store different types of data in various registers including, without limitation, integer registers, floating point registers, status registers, and instruction pointer register.

In at least one embodiment, execution unit 808, including, without limitation, logic to perform integer and floating point operations, also resides in processor 802. In at least one embodiment, processor 802 may also include a microcode (“ucode”) read only memory (“ROM”) that stores microcode for certain macro instructions. In at least one embodiment, execution unit 808 may include logic to handle a packed instruction set 809. In at least one embodiment, by including packed instruction set 809 in an instruction set of a general-purpose processor 802, along with associated circuitry to execute instructions, operations used by many multimedia applications may be performed using packed data in a general-purpose processor 802. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 808 may also be used in microcontrollers, embedded processors, graphics devices, DSPs, and other types of logic circuits. In at least one embodiment, computer system 800 may include, without limitation, a memory 820. In at least one embodiment, memory 820 may be implemented as a Dynamic Random Access Memory (“DRAM”) device, a Static Random Access Memory (“SRAM”) device, flash memory device, or other memory device. In at least one embodiment, memory 820 may store instruction(s) 819 and/or data 821 represented by data signals that may be executed by processor 802.

In at least one embodiment, system logic chip may be coupled to processor bus 810 and memory 820. In at least one embodiment, system logic chip may include, without limitation, a memory controller hub (“MCH”) 816, and processor 802 may communicate with MCH 816 via processor bus 810. In at least one embodiment, MCH 816 may provide a high bandwidth memory path 818 to memory 820 for instruction and data storage and for storage of graphics commands, data and textures. In at least one embodiment, MCH 816 may direct data signals between processor 802, memory 820, and other components in computer system 800 and to bridge data signals between processor bus 810, memory 820, and a system I/O 822. In at least one embodiment, system logic chip may provide a graphics port for coupling to a graphics controller. In at least one embodiment, MCH 816 may be coupled to memory 820 through a high bandwidth memory path 818 and graphics/video card 812 may be coupled to MCH 816 through an Accelerated Graphics Port (“AGP”) interconnect 814.

In at least one embodiment, computer system 800 may use system I/O 822 that is a proprietary hub interface bus to couple MCH 816 to I/O controller hub (“ICH”) 830. In at least one embodiment, ICH 830 may provide direct connections to some I/O devices via a local I/O bus. In at least one embodiment, local I/O bus may include, without limitation, a high-speed I/O bus for connecting peripherals to memory 820, chipset, and processor 802. Examples may include, without limitation, an audio controller 829, a firmware hub (“flash BIOS”) 828, a wireless transceiver 826, a data storage 824, a legacy I/O controller 823 containing user input and keyboard interface(s) 825, a serial expansion port 827, such as Universal Serial Bus (“USB”), and a network controller 834. Data storage 824 may comprise a hard disk drive, a floppy disk drive, a CD-ROM device, a flash memory device, or other mass storage device.

In at least one embodiment, FIG. 8 illustrates a system, which includes interconnected hardware devices or “chips”, whereas in other embodiments, FIG. 8 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 800 are interconnected using compute express link (CXL) interconnects.

Inference and/or training logic 715 are used to perform inferencing and/or training operations associated with one or more embodiments. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used for path routing.

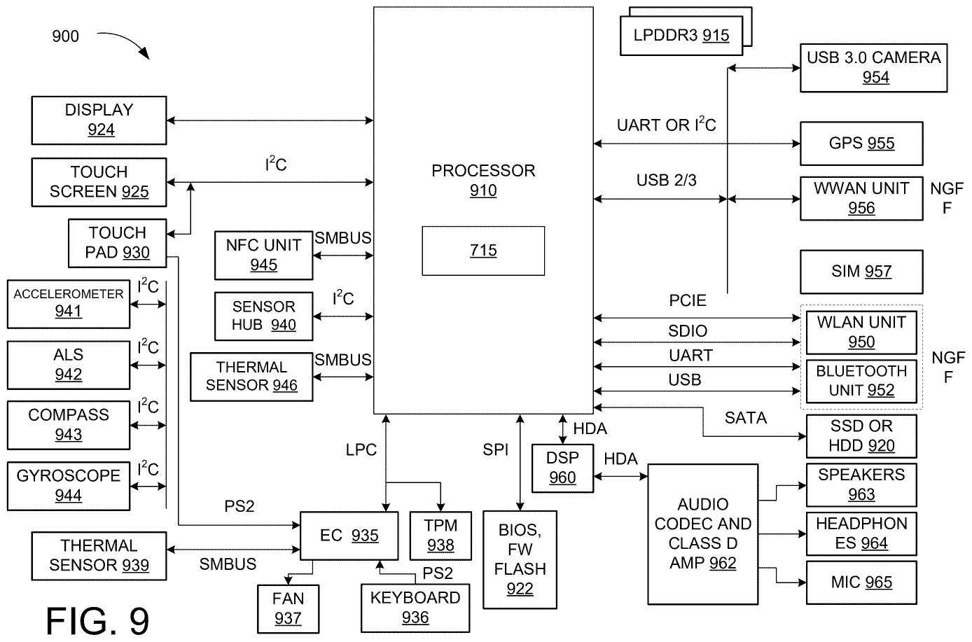

FIG. 9 is a block diagram illustrating an electronic device 900 for utilizing a processor 910, according to at least one embodiment. In at least one embodiment, electronic device 900 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 900 may include, without limitation, processor 910 communicatively coupled to any suitable number or kind of components, peripherals, modules, or devices. In at least one embodiment, processor 910 coupled using a bus or interface, such as a 1 °C bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices illustrated in FIG. 9 may be interconnected with proprietary interconnects, standardized interconnects (e.g., PCIe) or some combination thereof. In at least one embodiment, one or more components of FIG. 9 are interconnected using compute express link (CXL) interconnects.

In at least one embodiment, FIG. 9 may include a display 924, a touch screen 925, a touch pad 930, a Near Field Communications unit (“NFC”) 945, a sensor hub 940, a thermal sensor 946, an Express Chipset (“EC”) 935, a Trusted Platform Module (“TPM”) 938, BIOS/firmware/flash memory (“BIOS, FW Flash”) 922, a DSP 960, a drive 920 such as a Solid State Disk (“SSD”) or a Hard Disk Drive (“HDD”), a wireless local area network unit (“WLAN”) 950, a Bluetooth unit 952, a Wireless Wide Area Network unit (“WWAN”) 956, a Global Positioning System (GPS) 955, a camera (“USB 3.0 camera”) 954 such as a USB 3.0 camera, and/or a Low Power Double Data Rate (“LPDDR”) memory unit (“LPDDR3”) 915 implemented in, for example, LPDDR3 standard. These components may each be implemented in any suitable manner.

In at least one embodiment, other components may be communicatively coupled to processor 910 through components discussed above. In at least one embodiment, an accelerometer 941, Ambient Light Sensor (“ALS”) 942, compass 943, and a gyroscope 944 may be communicatively coupled to sensor hub 940. In at least one embodiment, thermal sensor 939, a fan 937, a keyboard 936, and a touch pad 930 may be communicatively coupled to EC 935. In at least one embodiment, speakers 963, headphones 964, and microphone (“mic”) 965 may be communicatively coupled to an audio unit (“audio codec and class d amp”) 962, which may in turn be communicatively coupled to DSP 960. In at least one embodiment, audio unit 964 may include, for example and without limitation, an audio coder/decoder (“codec”) and a class D amplifier. In at least one embodiment, SIM card (“SIM”) 957 may be communicatively coupled to WWAN unit 956. In at least one embodiment, components such as WLAN unit 950 and Bluetooth unit 952, as well as WWAN unit 956 may be implemented in a Next Generation Form Factor (“NGFF”).

Inference and/or training logic 715 are used to perform inferencing and/or training operations associated with one or more embodiments. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used for path routing.

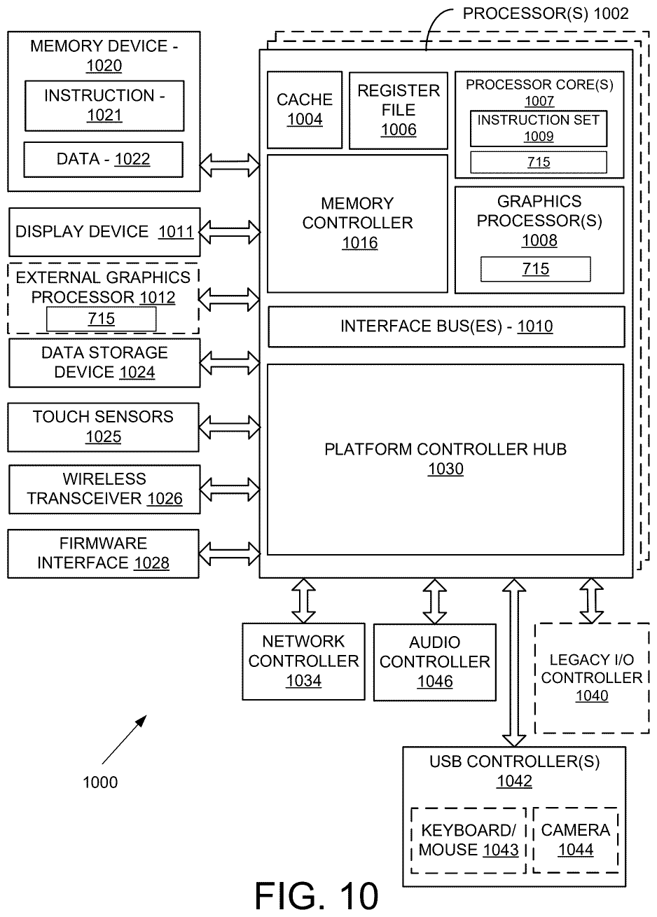

FIG. 10 is a block diagram of a processing system, according to at least one embodiment. In at least one embodiment, system 1000 includes one or more processor(s) 1002 and one or more graphics processor(s) 1008, and may be a single processor desktop system, a multiprocessor workstation system, or a server system having a large number of processor(s) 1002 or processor core(s) 1007. In at least one embodiment, system 1000 is a processing platform incorporated within a system-on-a-chip (SoC) integrated circuit for use in mobile, handheld, or embedded devices.

In at least one embodiment, system 1000 can include, or be incorporated within a server-based gaming platform, a game console, including a game and media console, a mobile gaming console, a handheld game console, or an online game console. In at least one embodiment, system 1000 is a mobile phone, smart phone, tablet computing device or mobile Internet device. In at least one embodiment, processing system 1000 can also include, couple with, or be integrated within a wearable device, such as a smart watch wearable device, smart eyewear device, augmented reality device, or virtual reality device. In at least one embodiment, processing system 1000 is a television or set top box device having one or more processor(s) 1002 and a graphical interface generated by one or more graphics processor(s) 1008.

In at least one embodiment, one or more processor(s) 1002 each include one or more processor core(s) 1007 to process instructions which, when executed, perform operations for system and user software. In at least one embodiment, each of one or more processor core(s) 1007 is configured to process a specific instruction set 1009. In at least one embodiment, instruction set 1009 may facilitate Complex Instruction Set Computing (CISC), Reduced Instruction Set Computing (RISC), or computing via a Very Long Instruction Word (VLIW). In at least one embodiment, processor core(s) 1007 may each process a different instruction set 1009, which may include instructions to facilitate emulation of other instruction sets. In at least one embodiment, processor core(s) 1007 may also include other processing devices, such a Digital Signal Processor (DSP).

In at least one embodiment, processor(s) 1002 includes cache memory 1004. In at least one embodiment, processor(s) 1002 can have a single internal cache or multiple levels of internal cache. In at least one embodiment, cache memory is shared among various components of processor(s) 1002. In at least one embodiment, processor(s) 1002 also uses an external cache (e.g., a Level-3 (L3) cache or Last Level Cache (LLC)) (not shown), which may be shared among processor core(s) 1007 using known cache coherency techniques. In at least one embodiment, register file 1006 is additionally included in processor(s) 1002 which may include different types of registers for storing different types of data (e.g., integer registers, floating point registers, status registers, and an instruction pointer register). In at least one embodiment, register file 1006 may include general-purpose registers or other registers.

In at least one embodiment, one or more processor(s) 1002 are coupled with one or more interface bus(es) 1010 to transmit communication signals such as address, data, or control signals between processor(s) 1002 and other components in system 1000. In at least one embodiment, interface bus(es) 1010, in one embodiment, can be a processor bus, such as a version of a Direct Media Interface (DMI) bus. In at least one embodiment, interface bus(es) 1010 is not limited to a DMI bus, and may include one or more Peripheral Component Interconnect buses (e.g., PCI, PCI Express), memory busses, or other types of interface busses. In at least one embodiment processor(s) 1002 include an integrated memory controller 1016 and a platform controller hub 1030. In at least one embodiment, memory controller 1016 facilitates communication between a memory device and other components of system 1000, while platform controller hub (PCH) 1030 provides connections to I/O devices via a local I/O bus.

In at least one embodiment, memory device 1020 can be a dynamic random access memory (DRAM) device, a static random access memory (SRAM) device, flash memory device, phase-change memory device, or some other memory device having suitable performance to serve as process memory. In at least one embodiment memory device 1020 can operate as system memory for system 1000, to store data 1022 and instruction 1021 for use when one or more processor(s) 1002 executes an application or process. In at least one embodiment, memory controller 1016 also couples with an optional external graphics processor 1012, which may communicate with one or more graphics processor(s) 1008 in processor(s) 1002 to perform graphics and media operations. In at least one embodiment, a display device 1011 can connect to processor(s) 1002. In at least one embodiment display device 1011 can include one or more of an internal display device, as in a mobile electronic device or a laptop device or an external display device attached via a display interface (e.g., DisplayPort, etc.). In at least one embodiment, display device 1011 can include a head mounted display (HMD) such as a stereoscopic display device for use in virtual reality (VR) applications or augmented reality (AR) applications.

In at least one embodiment, platform controller hub 1030 enables peripherals to connect to memory device 1020 and processor(s) 1002 via a high-speed I/O bus. In at least one embodiment, I/O peripherals include, but are not limited to, an audio controller 1046, a network controller 1034, a firmware interface 1028, a wireless transceiver 1026, touch sensors 1025, a data storage device 1024 (e.g., hard disk drive, flash memory, etc.). In at least one embodiment, data storage device 1024 can connect via a storage interface (e.g., SATA) or via a peripheral bus, such as a Peripheral Component Interconnect bus (e.g., PCI, PCI Express). In at least one embodiment, touch sensors 1025 can include touch screen sensors, pressure sensors, or fingerprint sensors. In at least one embodiment, wireless transceiver 1026 can be a Wi-Fi transceiver, a Bluetooth transceiver, or a mobile network transceiver such as a 3G, 4G, or Long Term Evolution (LTE) transceiver. In at least one embodiment, firmware interface 1028 enables communication with system firmware, and can be, for example, a unified extensible firmware interface (UEFI). In at least one embodiment, network controller 1034 can enable a network connection to a wired network. In at least one embodiment, a high-performance network controller (not shown) couples with interface bus(es) 1010. In at least one embodiment, audio controller 1046 is a multi-channel high definition audio controller. In at least one embodiment, system 1000 includes an optional legacy I/O controller 1040 for coupling legacy (e.g., Personal System 2 (PS/2)) devices to system. In at least one embodiment, platform controller hub 1030 can also connect to one or more Universal Serial Bus (USB) controller(s) 1042 connect input devices, such as keyboard and mouse 1043 combinations, a camera 1044, or other USB input devices.

In at least one embodiment, an instance of memory controller 1016 and platform controller hub 1030 may be integrated into a discreet external graphics processor, such as external graphics processor 1012. In at least one embodiment, platform controller hub 1030 and/or memory controller 1016 may be external to one or more processor(s) 1002. For example, in at least one embodiment, system 1000 can include an external memory controller 1016 and platform controller hub 1030, which may be configured as a memory controller hub and peripheral controller hub within a system chipset that is in communication with processor(s) 1002.

Inference and/or training logic 715 are used to perform inferencing and/or training operations associated with one or more embodiments. In at least one embodiment portions or all of inference and/or training logic 715 may be incorporated into graphics processor(s) 1008. For example, in at least one embodiment, training and/or inferencing techniques described herein may use one or more of ALUs embodied in a graphics processor. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used for path routing.

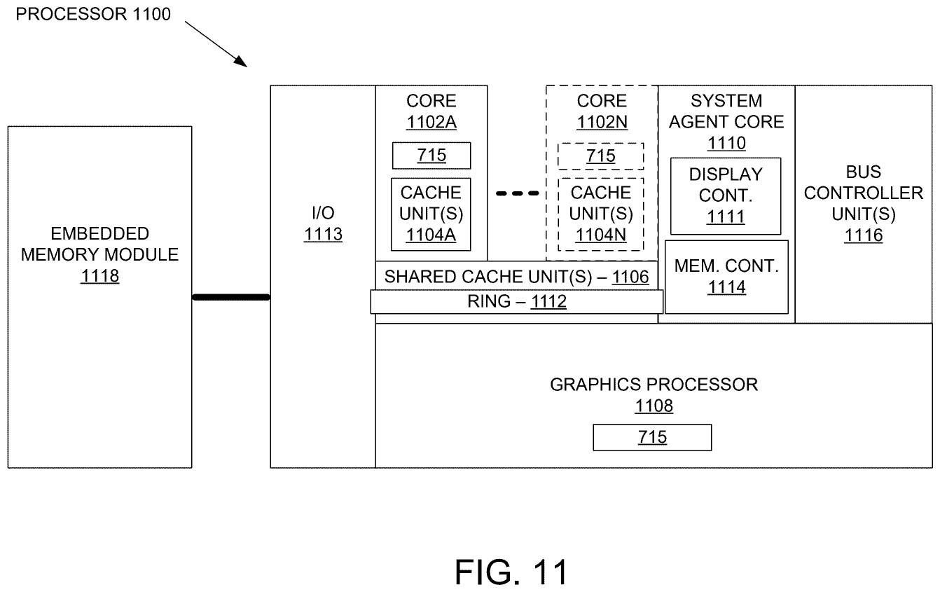

FIG. 11 is a block diagram of a processor 1100 having one or more processor core(s) 1102A-1102N, an integrated memory controller 1114, and an integrated graphics processor 1108, according to at least one embodiment. In at least one embodiment, processor 1100 can include additional cores up to and including additional core 1102N represented by dashed lined boxes. In at least one embodiment, each of processor core(s) 1102A-1102N includes one or more internal cache unit(s) 1104A-1104N. In at least one embodiment, each processor core also has access to one or more shared cached unit(s) 1106.

In at least one embodiment, internal cache unit(s) 1104A-1104N and shared cache unit(s) 1106 represent a cache memory hierarchy within processor 1100. In at least one embodiment, cache unit(s) 1104A-1104N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1106 and 1104A-1104N.

In at least one embodiment, processor 1100 may also include a set of one or more bus controller unit(s) 1116 and a system agent core 1110. In at least one embodiment, one or more bus controller unit(s) 1116 manage a set of peripheral buses, such as one or more PCI or PCI express busses. In at least one embodiment, system agent core 1110 provides management functionality for various processor components. In at least one embodiment, system agent core 1110 includes one or more integrated memory controllers 1114 to manage access to various external memory devices (not shown).

In at least one embodiment, one or more of processor core(s) 1102A-1102N include support for simultaneous multi-threading. In at least one embodiment, system agent core 1110 includes components for coordinating and operating processor core(s) 1102A-1102N during multi-threaded processing. In at least one embodiment, system agent core 1110 may additionally include a power control unit (PCU), which includes logic and components to regulate one or more power states of processor core(s) 1102A-1102N and graphics processor 1108.

In at least one embodiment, processor 1100 additionally includes graphics processor 1108 to execute graphics processing operations. In at least one embodiment, graphics processor 1108 couples with shared cache unit(s) 1106, and system agent core 1110, including one or more integrated memory controllers 1114. In at least one embodiment, system agent core 1110 also includes a display controller 1111 to drive graphics processor output to one or more coupled displays. In at least one embodiment, display controller 1111 may also be a separate module coupled with graphics processor 1108 via at least one interconnect, or may be integrated within graphics processor 1108.

In at least one embodiment, a ring based interconnect unit 1112 is used to couple internal components of processor 1100. In at least one embodiment, an alternative interconnect unit may be used, such as a point-to-point interconnect, a switched interconnect, or other techniques. In at least one embodiment, graphics processor 1108 couples with ring based interconnect unit 1112 via an I/O link 1113.

In at least one embodiment, I/O link 1113 represents at least one of multiple varieties of I/O interconnects, including an on package I/O interconnect which facilitates communication between various processor components and a high-performance embedded memory module 1118, such as an eDRAM module. In at least one embodiment, each of processor core(s) 1102A-1102N and graphics processor 1108 use embedded memory modules 1118 as a shared Last Level Cache.

In at least one embodiment, processor core(s) 1102A-1102N are homogenous cores executing a common instruction set architecture. In at least one embodiment, processor core(s) 1102A-1102N are heterogeneous in terms of instruction set architecture (ISA), where one or more of processor core(s) 1102A-1102N execute a common instruction set, while one or more other cores of processor core(s) 1102A-1102N executes a subset of a common instruction set or a different instruction set. In at least one embodiment, processor core(s) 1102A-1102N are heterogeneous in terms of microarchitecture, where one or more cores having a relatively higher power consumption couple with one or more power cores having a lower power consumption. In at least one embodiment, processor 1100 can be implemented on one or more chips or as an SoC integrated circuit.

Inference and/or training logic 715 are used to perform inferencing and/or training operations associated with one or more embodiments. In at least one embodiment portions or all of inference and/or training logic 715 may be incorporated into processor 1100. For example, in at least one embodiment, training and/or inferencing techniques described herein may use one or more of ALUs embodied in graphics processor 1108, processor core(s) 1102A-1102N, or other components in FIG. 11. In at least one embodiment, weight parameters may be stored in on-chip or off-chip memory and/or registers (shown or not shown) that configure ALUs of graphics processor 1100/1108 to perform one or more machine learning algorithms, neural network architectures, use cases, or training techniques described herein.

Such components can be used for path routing.

Various embodiments can be described by the following clauses:
1. A processor, comprising:
one or more circuits to:
determine a first number of transmissions exceeds a first threshold, the first number of transmissions associated with at least a first control packet and a second control packet transmitted along a network path between a first host device and a second host device;
cause traffic along the network path to be reduced over a first period of time, responsive to determining the first number of transmissions exceeds the first threshold;
cause a routing table, for the traffic, to direct the traffic away from the network path;
determine a second number of transmissions exceeds a second threshold, the second number of transmissions associated with at least a third control packet transmitted along the network path; and
cause traffic along the network path to be increased over a second period of time, responsive to determining the second number of transmissions exceeds the second threshold.
2. The processor clause 1, wherein the first host device is a first network interface controller (NIC) and the second host device is a second NIC.
3. The processor of clause 2, wherein the routing table is controlled by the first NIC.
4. The processor of clause 1, wherein the routing table is associated with a software stack hosted on the first host device.
5. The processor of clause 1, wherein the one or more circuits are further to:
cause the routing table, for the traffic, to direct the traffic to the network path, responsive to determining the second number of transmissions exceeds the second threshold.
6. The processor of clause 1, wherein the one or more circuits are further to:
determine traffic along the network path exceeds a threshold size.
7. The processor of clause 1, wherein the first threshold includes at least one of a number of consecutive failures or a time out period.
8. A network interface controller (NIC), comprising:
one or more processing circuits, to:
determine a size of a data packet, associated with a first request to transmit the data packet to a second NIC along a first path, exceeds a first threshold;
responsive to determining the size of the data packet exceeds the first threshold, transmit a probe and the data packet along the first path;
determine, based on one or more properties of the probe, that the first path is unresponsive;
set a rate for the first path to a reduced value; and
receive a second request to transmit the data packet to the second NIC along a second path.
9. The NIC of clause 8, wherein the one or more processing circuits are further to:
determine, based on one or more second properties of a second probe transmitted along the first path, that the first path is responsive;
set the rate for the first path to an increased value; and
receive a third request to transmit a second data packet to the second NIC along the first path.
10. The NIC of clause 8, wherein the reduced value is approximately zero.
11. The NIC of clause 8, wherein the one or more properties include at least one of a consecutive number of failed transmissions or a time out period.
12. The NIC of clause 8, wherein the first path includes at least one of an ethernet or an InfiniBand protocol.
13. The NIC of clause 8, wherein the first path is associated with at least one of a multiplane or a multipath network topology.
14. The NIC of clause 8, wherein a software routing stack updates one or more routing tables responsive to the reduced value.
15. The NIC of clause 8, wherein a transmission size of the probe is less than one half percent of the size.
16. A computer-implemented method, comprising:
transmitting one or more probes along a network path between a first host device and a second host device, responsive to a request to transmit a data packet;
determining, based at least in part on individual statuses of the one or more probes, a health of the network path is below a threshold;
reducing a rate for the network path, responsive to the health of the network path;
causing a routing table, for traffic between the first host device and the second host device, to direct the traffic away from the network path; and
transmitting, responsive to instructions associated with the routing table, one or more second data packets along a second network path between the first host device and the second host device.
17. The computer-implemented method of clause 16, further comprising:
transmitting one or more second probes along the network path;
determining, based at least in part on individual statuses of the one or more second probes, the health of the network path at least meets the threshold;
increasing the rate for the network path, responsive to the health of the network path; and
causing the routing table, for traffic between the first host device and the second host device, to direct the traffic to the network path.
18. The computer-implemented method of clause 16, further comprising:
causing traffic along the network path to be reduced over a first period of time.
19. The computer-implemented method of clause 16, wherein the first host device is a first network interface controller (NIC), the second host device is a second NIC, and the routing table is controlled by the first NIC.
20. The computer-implemented method of clause 16, wherein the routing table is associated with a software stack hosted on the first host device.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor, comprising:
one or more circuits to:
determine a first number of transmissions exceeds a first threshold, the first number of transmissions associated with at least a first control packet and a second control packet transmitted along a network path between a first host device and a second host device;
cause traffic along the network path to be reduced over a first period of time, responsive to determining the first number of transmissions exceeds the first threshold;
cause a routing table, for the traffic, to direct the traffic away from the network path;
determine a second number of transmissions exceeds a second threshold, the second number of transmissions associated with at least a third control packet transmitted along the network path; and
cause traffic along the network path to be increased over a second period of time, responsive to determining the second number of transmissions exceeds the second threshold.

2. The processor claim 1, wherein the first host device is a first network interface controller (NIC) and the second host device is a second NIC.

3. The processor of claim 2, wherein the routing table is controlled by the first NIC.

4. The processor of claim 1, wherein the routing table is associated with a software stack hosted on the first host device.

5. The processor of claim 1, wherein the one or more circuits are further to:
cause the routing table, for the traffic, to direct the traffic to the network path, responsive to determining the second number of transmissions exceeds the second threshold.

6. The processor of claim 1, wherein the one or more circuits are further to:
determine traffic along the network path exceeds a threshold size.

7. The processor of claim 1, wherein the first threshold includes at least one of a number of consecutive failures or a time out period.

8. A network interface controller (NIC), comprising:
one or more processing circuits, to:
determine a size of a data packet, associated with a first request to transmit the data packet to a second NIC along a first path, exceeds a first threshold;
responsive to determining the size of the data packet exceeds the first threshold, transmit a probe and the data packet along the first path;
determine, based on one or more properties of the probe, that the first path is unresponsive;
set a rate for the first path to a reduced value; and
receive a second request to transmit the data packet to the second NIC along a second path.

9. The NIC of claim 8, wherein the one or more processing circuits are further to:
determine, based on one or more second properties of a second probe transmitted along the first path, that the first path is responsive;
set the rate for the first path to an increased value; and
receive a third request to transmit a second data packet to the second NIC along the first path.

10. The NIC of claim 8, wherein the reduced value is approximately zero.

11. The NIC of claim 8, wherein the one or more properties include at least one of a consecutive number of failed transmissions or a time out period.

12. The NIC of claim 8, wherein the first path includes at least one of an ethernet or an InfiniBand protocol.

13. The NIC of claim 8, wherein the first path is associated with at least one of a multiplane or a multipath network topology.

14. The NIC of claim 8, wherein a software routing stack updates one or more routing tables responsive to the reduced value.

15. The NIC of claim 8, wherein a transmission size of the probe is less than one half percent of the size.

16. A computer-implemented method, comprising:
transmitting one or more probes along a network path between a first host device and a second host device, responsive to a request to transmit a data packet;
determining, based at least in part on individual statuses of the one or more probes, a health of the network path is below a threshold;
reducing a rate for the network path, responsive to the health of the network path;
causing a routing table, for traffic between the first host device and the second host device, to direct the traffic away from the network path; and
transmitting, responsive to instructions associated with the routing table, one or more second data packets along a second network path between the first host device and the second host device.

17. The computer-implemented method of claim 16, further comprising:
transmitting one or more second probes along the network path;
determining, based at least in part on individual statuses of the one or more second probes, the health of the network path at least meets the threshold;
increasing the rate for the network path, responsive to the health of the network path; and
causing the routing table, for traffic between the first host device and the second host device, to direct the traffic to the network path.

18. The computer-implemented method of claim 16, further comprising:
causing traffic along the network path to be reduced over a first period of time.

19. The computer-implemented method of claim 16, wherein the first host device is a first network interface controller (NIC), the second host device is a second NIC, and the routing table is controlled by the first NIC.

20. The computer-implemented method of claim 16, wherein the routing table is associated with a software stack hosted on the first host device.
